(19) United States
(12) Patent Application Publication
(10) Pub. No.: US 2025/0209321 A1
(43) Pub. Date: Jun. 26, 2025

(54) SYSTEM IDENTIFICATION APPARATUS, SYSTEM IDENTIFICATION METHOD AND NON-TRANSITORY STORAGE MEDIUM

(71) Applicant: NEC Corporation, Tokyo (JP)

(72) Inventor: Hiroshi YOSHIDA, Tokyo (JP)

(73) Assignee: NEC Corporation, Tokyo (JP)

(21) Appl. No.: 18/966,407

(22) Filed: Dec. 3, 2024

(30) Foreign Application Priority Data
Dec. 22, 2023 (JP) 2023-217257

(51) Int. Cl. G06N 3/08; G06N 3/044

(52) U.S. Cl. CPC G06N 3/08; G06N 3/044

(57) ABSTRACT

A system identification apparatus acquires time series data of input values to an identification target and observed values indicating states of the identification target; constructs a first model obtained by identification of the identification target by training with the time series data; removes noise from the time series data based on the time series data and predicted values of states of the identification target predicted by the first model based on the time series data; and constructs a second model obtained by identification of the identification target by training with the time series data from which the noise has been removed.

This application is based upon and claims the benefit of priority from Japanese patent application No. 2023-217257, filed Dec. 22, 2023, the disclose of which is incorporated herein in its entirety by reference.

### TECHNICAL FIELD

The present disclosure relates to a system identification apparatus, a system identification method and a non-transitory storage medium.

### BACKGROUND ART

Patent Document 1 (Japanese Unexamined Patent Application Publication No. 2020-185284) discloses a system for estimating the drowsiness of a user from observed values such as the pulse and the respiration of the user seated in an automobile or at a desk by means of a trained model constructed with an echo state network (ESN). An ESN, like a recurrent neural network, is composed of an input layer, a reservoir layer, and an output layer. However, in the case of an ESN, the model is constructed by randomly generating the input layer and the reservoir layer without thereafter training them, and training only the output layer. For this reason, the computational cost required for training is low and the model can be constructed in a short time. An ESN is a type of reservoir computing. By using an ESN, for example, a model can be constructed by quickly identifying a system during operation of a machine or the like that is a modeling target, the future state of the target can be predicted by means of the constructed model, and the prediction can be utilized for control and the like.

By using an ESN, system identification can be performed with high accuracy in a short time. However, when observed values from sensors or the like are used as training data, there is a possibility of the accuracy of the model being reduced due to the influence of noise included in the observed values.

### SUMMARY

One objective of the present disclosure is to provide a system identification apparatus, a system identification method, and a non-transitory storage medium.

According to an example of an aspect disclosed herein, a system identification apparatus includes: at least one memory configured to store instructions; and at least one processor configured to execute the instructions to acquire time series data of input values to an identification target and observed values indicating states of the identification target; construct a first model obtained by identification of the identification target by training with the time series data; remove noise from the time series data based on the time series data and predicted values of states of the identification target predicted by the first model based on the time series data; and construct a second model obtained by identification of the identification target by training with the time series data from which the noise has been removed.

According to an example of an aspect disclosed herein, a system identification method includes steps of acquiring time series data of input values to an identification target and observed values indicating states of the identification target; constructing a first model obtained by identification of the identification target by training with the time series data; removing noise from the time series data based on the time series data and predicted values of states of the identification target predicted by the first model based on the time series data; and constructing a second model obtained by identification of the identification target by training with the time series data from which the noise has been removed.

According to an example of an aspect disclosed herein, a program stored in a non-transitory storage medium makes a computer execute processes for: acquiring time series data of input values to an identification target and observed values indicating states of the identification target; constructing a first model obtained by identification of the identification target by training with the time series data; removing noise from the time series data based on the time series data and predicted values of states of the identification target predicted by the first model based on the time series data; and constructing a second model obtained by identification of the identification target by training with the time series data from which the noise has been removed.

### BRIEF DESCRIPTION OF THE DRAWINGS

FIG. 1 is a diagram illustrating an example of a system identification apparatus according to an example embodiment.

FIG. 2 is a diagram illustrating a configuration example of a system identification process according to an example embodiment.

FIG. 3 is a flow chart indicating an example of a system identification process according to an example embodiment.

FIG. 4 is a flow chart indicating an example of a prediction process according to an example embodiment.

FIG. 5 is a first diagram illustrating an example of a prediction result based on observed values not including noise.

FIG. 6 is a first diagram illustrating an example of a prediction result based on observed values including noise.

FIG. 7 is a first diagram illustrating an example of a prediction result based on observed values including noise using an ESN according to an example embodiment.

FIG. 8 is a second diagram illustrating an example of a prediction result based on observed values not including noise.

FIG. 9 is a second diagram illustrating an example of a prediction result based on observed values including noise.

FIG. 10 is a second diagram illustrating an example of a prediction result based on observed values including noise using an ESN according to a first example embodiment.

FIG. 11 is a second diagram illustrating a configuration example of a system identification process according to an example embodiment.

FIG. 12 is a second diagram illustrating an example of a system identification apparatus according to an example embodiment.

FIG. 13 is a second flow chart indicating an example of a system identification process according to an example embodiment.

FIG. 14 is a diagram illustrating an example of a hardware configuration of a system identification apparatus according to an example embodiment.

### EXAMPLE EMBODIMENTS

Hereinafter, system identification apparatuses 10 according to example embodiments disclosed herein will be explained with reference to the drawings. Regarding the features in portions unrelated to the present disclosure in the drawings used for the explanation below, there are cases in which descriptions are omitted and they are not illustrated. Identical or corresponding features in all of the drawings are assigned identical reference signs, and there are cases in which redundant explanations are omitted.

### First Example Embodiment

### (Configuration of Apparatus)

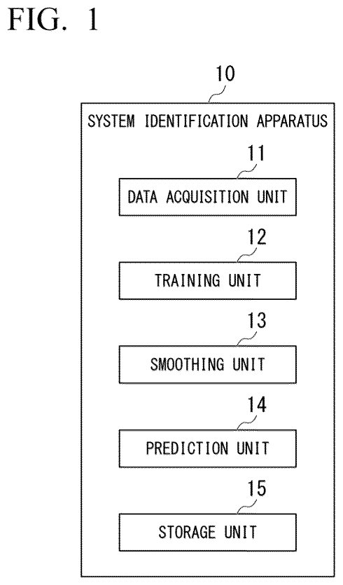

FIG. 1 is a diagram illustrating an example of a system identification apparatus according to an example embodiment.

The system identification apparatus 10, as illustrated in FIG. 1, is provided with a data acquisition unit 11, a training unit 12, a smoothing unit 13, a prediction unit 14, and a storage unit 15.

The system identification apparatus 10 constructs a reservoir computing model, such as an ESN, by training with observed values measured with a sensor or the like regarding the state or the behavior of a machine, a system, or the like that is a modeling target, thereby performing system identification of the target. Additionally, the system identification apparatus 10 uses the constructed model to make future predictions regarding the target. The system identification apparatus 10 can identify a non-linear dynamical system in real time and can use said non-linear dynamical system for the purpose of predicting future states thereof.

In the explanation below, the explanation will be made with an ESN as an example of a reservoir computing model. However, the present disclosure can also be applied to models constructed by other methods. Furthermore, the present disclosure can be applied not only to reservoir computing, but also to training of models constructed by various types of machine learning, deep learning and system identification methods.

The data acquisition unit 11 acquires time series data of input values (operation amounts and control values) and observed values (states) measured with a sensor or the like, and records the time series data in the storage unit 15. The acquired data is used to train an ESN and to predict the future of a target based on the ESN. In this case, the target is a non-linear dynamical system for the dynamics of a mobile body such as an AGV (Automatic Guided Vehicle), a forklift, an automobile, or a rough-terrain transport vehicle, or for the dynamics of a robot, such as arm operation of a hydraulic shovel or fork operation of a forklift. In the case in which the target is the dynamics of a mobile body, the observed values are values indicating the state of the mobile body measured by a sensor for the position, orientation, velocity, angular velocity, etc., and the input values are motor rotation speeds, lever operation amounts, steering wheel operation amounts, operation amounts of accelerators and brakes, etc. In the case in which the target is arm operation of a hydraulic shovel, the observed values are values indicating the state of an arm measured by a sensor for the angle and the angular velocity of a bucket, an arm, a boom, etc., and the input values are lever operation amounts regarding the bucket, the arm, the boom, etc. In the case in which the target is fork operation of a forklift, the observed values are measured values from a sensor indicating the state of a fork, such as the fork position and the speeds of lift, tilt, reach, etc., and the input values are lever operation amounts regarding lift, tilt, reach, etc.

The training unit 12 constructs an ESN by using, as training data, the time series data of the observed values and the input values acquired by the data acquisition unit 11. For example, in the case in which the target is the dynamics of a moving body, the ESN trains an output layer so that, when an observed value (state) at a time t and an input value (operation amount) at the time t are input to the ESN, the state of the mobile body at the time t+1 is output. For example, in the case in which the target is arm operation of a hydraulic shovel, the ESN trains an output layer so that, when an observed value (state) at a time t and an input value (operation amount) at the time t are input to the ESN, the state of the arm at the time t+1 is output. In a common ESN, measured values measured with sensors are used as the observed values of the input and output in this training step. However, in the present example embodiment, training is performed by using, instead of measured values from sensors, values that have been smoothed by removing noise by means of a Kalman smoother (EKS: Extended Kalman Smoother). As a result thereof, decreases in the accuracy of generated ESNs that occur in the case in which they are trained with only observed values that include noise are reduced. For example, in order to prepare a model for outputting predicted values of the state of a modeling target required in a Kalman smoother, the time series data of the measured values and the input values acquired by the data acquisition unit 11 are used to train the ESN so that, when the observed values and the input values at the time t are input, the observed values at the time t+1 are output. The ESN constructed by this training will be referred to as a “first-stage ESN”. The first-stage ESN outputs time series data of the predicted values of the state of the modeling target based on the time series data of the observed values and the input values acquired by the data acquisition unit 11. The time series data of the predicted values of the state of the modeling target output by the first-stage ESN undergo noise removal by means of a process in the smoothing unit 13 to be explained next, thereby becoming time series data (hereinafter referred to as “close-to-true time series data”) of values indicating the state of the modeling target that are close to the true values. When this close-to-true time series data is obtained, the training unit 12 trains the ESN so that, when the input value at the time t acquired by the data acquisition unit 11 and the value at the time t of the close-to-true time series data are input, the value at the time t+1 of the close-to-true time series data is output. The ESN constructed by this training will be referred to as a “second-stage ESN”. When controlling moving bodies or robots, the values measured by sensors can include noise, and even if system identification is performed based on observed values including noise, an accurate model cannot be obtained. Therefore, with the present example embodiment, a process for removing noise from the observed values is performed, and time series data from which noise has been removed is used to perform system identification.

The smoothing unit 13, by means of a Kalman smoother, smooths the time series data output by the first-stage ESN constructed by the training unit 12. The smoothing unit 13 acquires the time series data of observed values and input values acquired by the data acquisition unit 11, and on the other hand, acquires time series data of predicted values for the state of the modeling target output by the first-stage ESN constructed by the training unit 12. Furthermore, by executing the Kalman smoother, the smoothing unit 13 calculates time series data (the “close-to-true time series data” above) of the observed values from which the noise included in the sensor measurement values has been removed from the observed values of the states. Since Kalman smoothers themselves are known, detailed explanations of the processing details will be omitted. However, a summary of the processes performed by the smoothing unit 13 can be explained in the following manner. First, the smoothing unit 13 executes a Kalman filter to calculate an estimated value of the state of the modeling target at a certain time t obtained by Bayesian estimation from the observed value at the time t and the predicted value for the time t output by the first-stage ESN. The smoothing unit 13 calculates time series data of the estimated values of the states by performing similar processes regarding respective times. The above is the process in the Kalman filter contained within the Kalman smoother. Next, the smoothing unit 13, while referencing the change in time series data of the observed values by the sensors acquired by the data acquisition unit 11, looks back on the time series to review the estimated values for the respective times estimated by the Kalman filter, determines whether or not the estimated values were correct, and corrects the estimated values for the respective times. This correcting process is the remaining process in the Kalman smoother. By removing the noise from the observed values and further reviewing and correcting the estimated values, by means of the Kalman smoother, the observed values of the states in the time series can be brought closer to the true values. In the case in which estimated values of the states are estimated by the Kalman smoother, instead of using a Kalman filter, the states may be estimated by means of another type of Bayesian filter such as a particle filter. Additionally, the smoothing method is not limited to being a Kalman smoother, and other methods may be applied. The close-to-true time series data after implementing the Kalman smoother is sent to the training unit 12 again and used to train the second-stage ESN.

The prediction unit 14 predicts the state of the modeling target using the ESN constructed by the training unit 12. For example, the prediction unit 14 outputs time series data of the state estimation values to be used in the Kalman smoother based on the time series data of the input values and the observed values acquired by the data acquisition unit 11, and the first-stage ESN. Additionally, for example, the prediction unit 14 outputs predicted values indicating states of the modeling target in the future based on the time series data of input values acquired by the data acquisition unit 11, the close-to-true time series data representing the states of the modeling target after smoothing, and the second-stage ESN.

The storage unit 15 stores various types of data necessary for system identification. For example, the storage unit 15 stores various types of data acquired by the data acquisition unit 11, the first-stage ESN and the second-stage ESN trained by the training unit 12, etc.

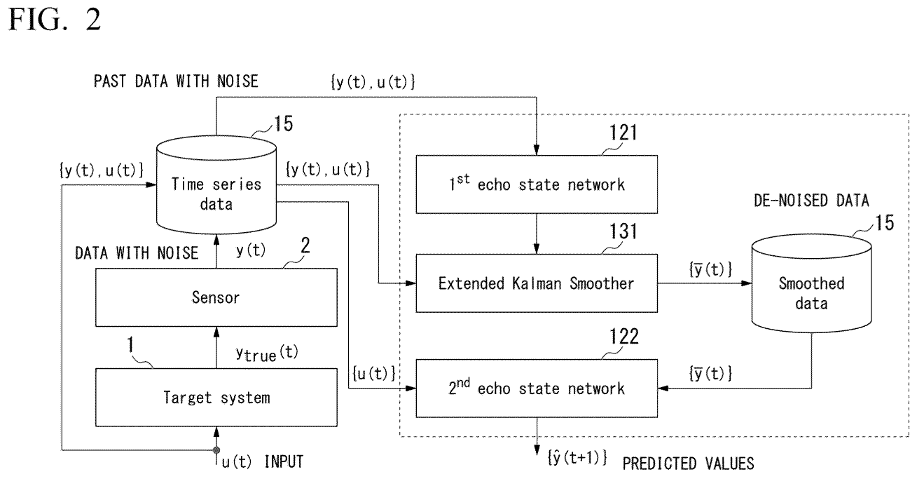

(Overall Configuration of Processes) FIG. 2 illustrates a configuration example of a process for constructing the two-stage ESN for the system 1. An input value u(t) at a time t is input to the system 1 of the identification target. In the system 1, the input of the input value u(t) causes the state to change to the state yₜᵣᵤₑ(t). When this state is detected by the sensor 2, an observed value y(t) is obtained. The system 1 and a system identification apparatus 10 are connected by a network, and the set of the input value u(t) and the observed value y(t) is recorded, for example, in the storage unit 15. In the system 1, input values u(t) are input from moment to moment, and a sensor 2 measures the states of the system 1 at the respective times. While the system 1 is operating, this process is repeatedly executed, and time series data of input values u(t) and observed values y(t) are accumulated in the storage unit 15. The values y(t) are past data with noise.

Next, the training unit 12 reads out the time series data of the input values u(t) and the observed values y(t) with noise from the storage unit 15, and constructs a first-stage ESN 121 by using this time series data as the training data. Next, the smoothing unit 13 uses the input values u(t) and the observed values y(t) with noise, and the first-stage ESN 121, to remove the noise from (de-noise) the time series data of the observed values y(t) by means of the Kalman smoother 131. The time series data of the de-noised observed values y⁻(t) (close-to-true time series data) is recorded in the storage unit 15. Next, the training unit 12 reads out the time series data of the de-noised y⁻(t) and the time series data of the input values u(t) from the storage unit 15, and uses this time series data as training data to construct a second-stage ESN 122. When the second-stage ESN 122 is constructed, subsequently, the second-stage ESN 122 is used to predict the future states of the system 1, and the predicted values are used to control the system 1, etc.

### (Training Process)

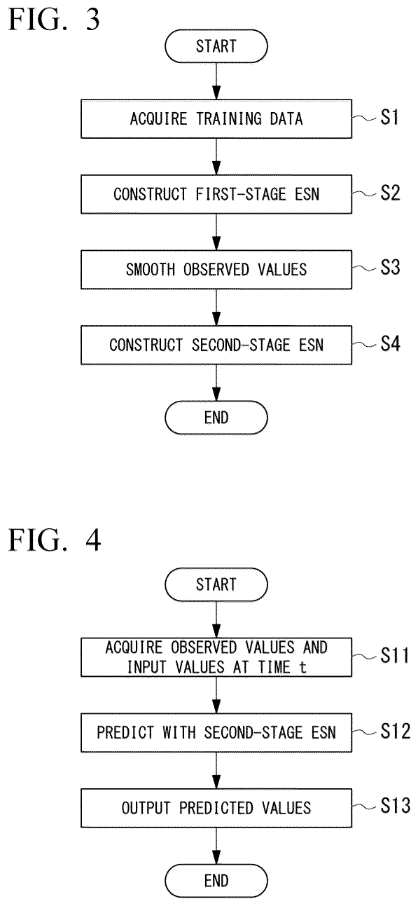

The flow of the process for constructing the ESNs will be explained with reference to FIG. 3.

FIG. 3 is a flow chart indicating an example of the system identification process according to an example embodiment.

The respective processes below indicated in FIG. 3 may, for example, be executed on-line in real time while machinery or the like that is the modeling target is running.

The data acquisition unit 11 acquires training data (step S1). For example, the data acquisition unit 11 acquires time series data of input values u(t) and observed values y(t) from the machinery or the like that is the modeling target, and records the time series data in the storage unit 15.

Next, the training unit 12 constructs the first-stage ESN 121 (step S2). The training unit 12, based on the time series data of the input values u(t) and the observed values y(t), constructs the first-stage ESN 121 so that, when input values u(t) and observed values y(t) are input, observed values y(t+1) are output. The training unit 12 records the constructed first-stage ESN 121 in the storage unit 15. The first-stage ESN 121 is used in the next Kalman smoother.

Next, the smoothing unit 13 smooths the observed values (step S3). The smoothing unit 13 executes a Kalman smoother based on the time series data of the input values u(t) and observed values y(t), and time series data of the observed values y⁻(t) predicted by the first-stage ESN 121 from the input values u(t) and the observed values y(t), thereby smoothing the time series data of the observed values y⁻(t). The smoothing unit 13 records time series data (close-to-true time series data) of the smoothed observed values y⁻(t) in the storage unit 15.

Next, the training unit 12 constructs the second-stage ESN 122 (step S4). The training unit 12, based on the time series data of the input values u(t) and the time series data of the smoothed observed values y⁻(t), constructs the second-stage ESN 122 so that, when input values u(t) and smoothed observed values y⁻(t) are input, smoothed observed values y⁻(t+1) are output. The training unit 12 records the constructed second-stage ESN 122 in the storage unit 15.

### (Prediction Process)

The flow of the prediction process by the constructed second-stage ESN will be explained with reference to FIG. 4.

FIG. 4 is a flow chart indicating an example of the prediction process according to an example embodiment.

The process below indicated in FIG. 4 may, for example, be executed on-line in real time while machinery or the like that is the modeling target is running.

The data acquisition unit 11 acquires an observed value and an input value for the time t (step S11). For example, the data acquisition unit 11 outputs, to the prediction unit 14, input values u(t) and observed values y(t) from the machinery or the like that is the modeling target.

Next, the prediction unit 14 uses the second-stage ESN 122 to make predictions (step S12). The prediction unit 14 inputs the input values u(t) and the observed values y(t) to the second-stage ESN 122 and obtains predicted values y\hat{ }(t+1) indicating the state of the target at the time t+1. In this case, the observed values y(t) that are input may be processed to remove noise included in a sensor. For example, the smoothing unit 13 may perform noise removal on the observed values y(t) in real time by means of a Bayesian filter such as a Kalman filter or a particle filter, and may output those values to the prediction unit 14. In this case, the prediction unit 14 inputs the input values u(t) and the de-noised observed values y(t) to the second-stage ESN 122 to predict the predicted values y\hat{ }(t+1) at the time t+1. Additionally, the second-stage ESN 122 may be constructed on-line in real time while machinery or the like that is the modeling target is running.

Next, the prediction unit 14 outputs the predicted values y\hat{ }(t+1) to another apparatus (for example, a control apparatus for a mobile body or a robot) (step S13).

### (Evaluation of Prediction Accuracy)

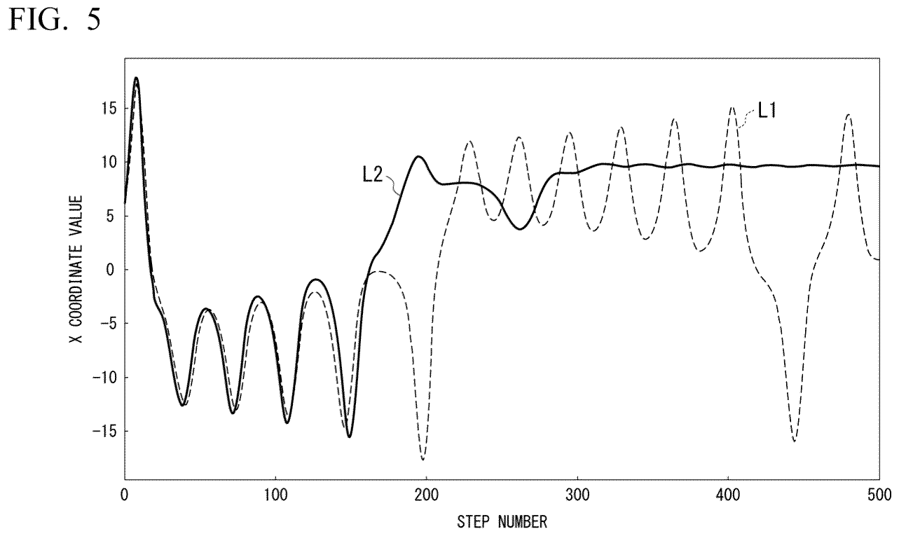

Next, the effects of the present example embodiment will be explained by referring to FIG. 5 to FIG. 10.

Identification methods for non-linear dynamical systems are evaluated by testing how correctly chaos systems can be predicted. Hereinafter, evaluation results of the prediction accuracy of the second-stage ESN will be indicated by using, as examples, a Lorenz system and a Rossler system, which are widely used as benchmarks.

### (Evaluation by Lorenz System)

FIG. 5 to FIG. 7 indicate evaluation results using a Lorenz system. In the evaluation of prediction accuracy by using a Lorenz system, the chaos system represented by the Lorenz equations below was provided with the initial values (x, y, z)=(1, 1, 1), σ=10, ρ=28, and β=8/3, and only x coordinate data for 1000 steps were used to train an ESN so as to predict the x coordinate value of a (T+1)-th step from the x coordinate value of a T-th step. Furthermore, for 500 steps following the 1000 steps used for training, the constructed ESN was used to successively predict the x coordinate values of the next steps to evaluate how accurately the predictions can be made.

$$\begin{matrix}Lorenz equations & \\ dx / dt = σ ( y - z ) & \end{matrix}$$

$$dy / dt = x ( ρ - z ) - y$$

$$dz / dt = zy - β z$$

FIG. 5 indicates an example of prediction results by an ESN constructed by training with observed data without noise.

In FIG. 5, the vertical axis indicates the x coordinate value and the horizontal axis indicates the step number. The graph L1 indicates the x coordinate values of the Lorenz system after the 1000 steps used for training, and the graph L2 indicates the x coordinate values predicted by the ESN. On the horizontal axis in FIG. 5, 0 represents the 1000-th step. As illustrated, the ESN can provide accurate predictions from the 0-th to around the 160-th step.

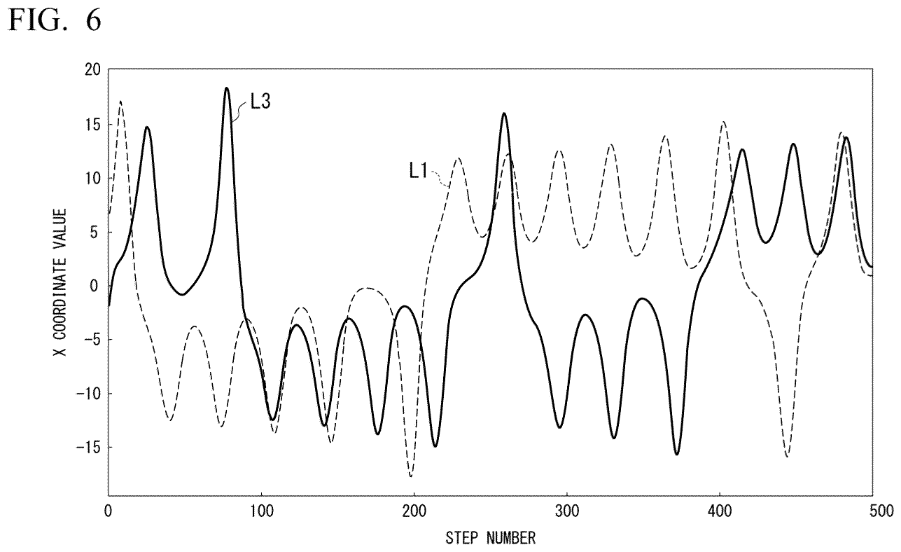

FIG. 6 indicates an example of prediction results by an ESN constructed by training in a state in which there is noise in the observed data.

In FIG. 6, the vertical axis indicates the x coordinate value and the horizontal axis indicates the step number. The training data (the x coordinate values for 1000 steps) for the ESN was provided with noise in accordance with a Gaussian distribution (mean μ =0, standard deviation σ=1.5). The graph L1 indicates the x coordinate values of the Lorenz system after the 1000 steps, and the graph L3 indicates the x coordinate values predicted by an ESN constructed with training data including noise (corresponding to the first-stage ESN). It can be seen that, compared with the example in FIG. 5, the prediction accuracy is lower. Thus, in the case in which there is observation noise, the prediction accuracy of the non-linear dynamical system by the ESN becomes lower.

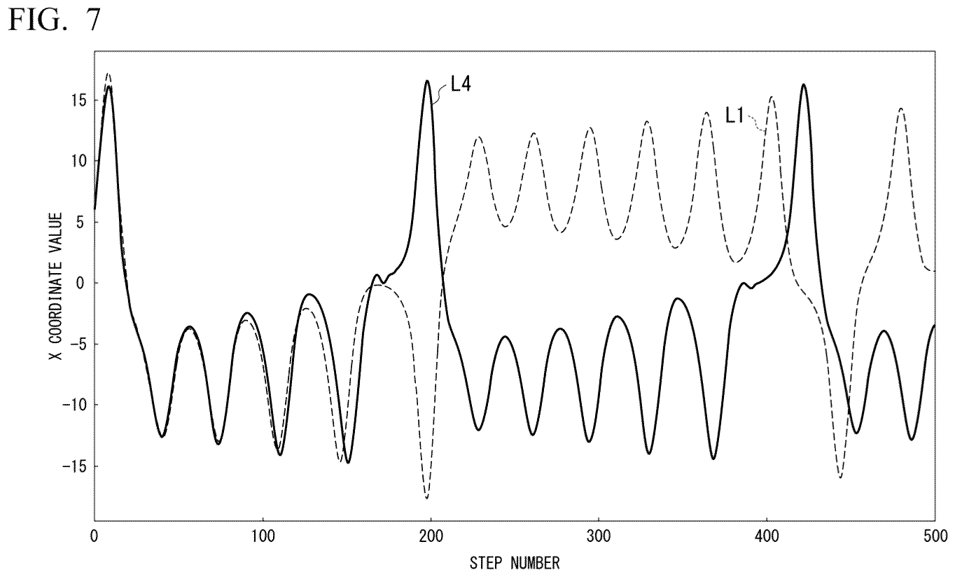

FIG. 7 indicates an example of prediction results by a second-stage ESN constructed by training with observed data including noise. The training data for the second-stage ESN was provided with noise similar to that in the case of FIG. 6. The graph L1 indicates the x coordinate values of the Lorenz system, and the graph L4 indicates the x coordinate values predicted by the second-stage ESN according to the present example embodiment constructed by means of training data including noise. It can be seen that prediction accuracy equal to or greater than the example indicated in FIG. 5 is obtained.

### (Evaluation by Rossler System)

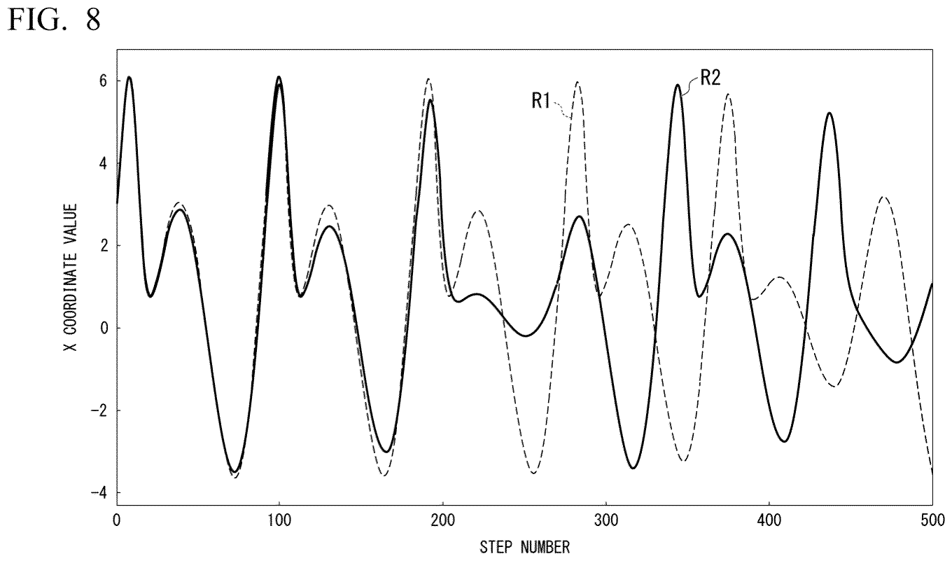

FIG. 8 to FIG. 10 indicate evaluation results using a Rossler system. In the evaluation using a Rossler system, the chaos system represented by the Rossler equations below was provided with the initial values (x, y, z)=(1, 1, 1), a=0.5, b=2, and c=4, and only x coordinate data for 1000 steps were used to train an ESN so as to predict the x coordinate value of a (T+1)-th step from the x coordinate value of a T-th step. Furthermore, for 500 steps following the 1000 steps used for training, the constructed ESN was used to successively predict the x coordinate values of the next steps to evaluate how accurately the predictions can be made.

$$\begin{matrix}Rossler equations & \\ dx / dt = - y - z & \end{matrix}$$

$$dy / dt = x + ay$$

$$dz / dt = b + ( x - c ) z$$

FIG. 8 indicates an example of prediction results by an ESN constructed by training with observed data without noise.

In FIG. 8, the vertical axis indicates the x coordinate value and the horizontal axis indicates the step number. The graph R1 indicates the x coordinate values of the Rossler system after the 1000 steps, and the graph R2 indicates the x coordinate values predicted by the ESN. As illustrated, x coordinate values can be accurately predicted by the ESN from the 0-th to a little over the 100-th step.

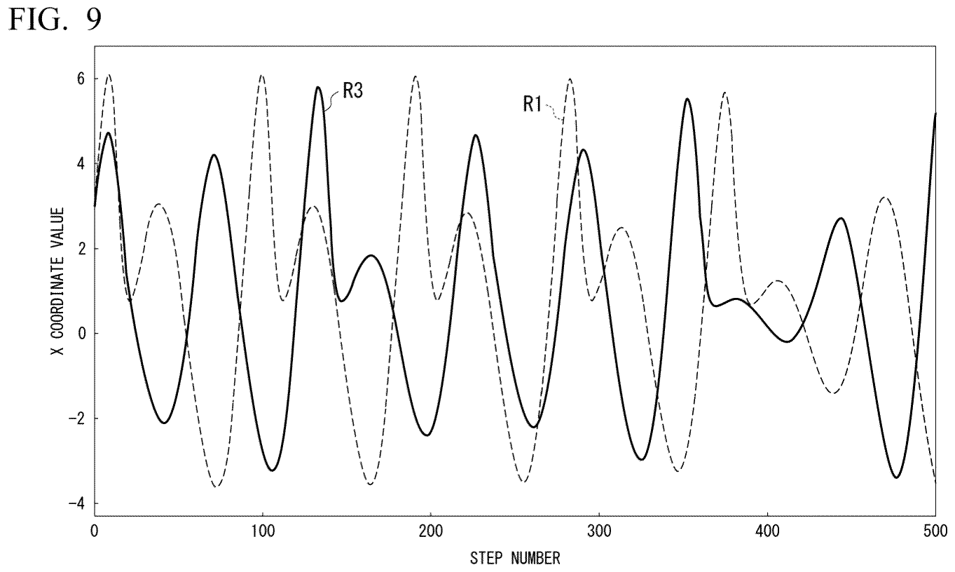

FIG. 9 indicates an example of prediction results by an ESN constructed by training with observed data including noise. In FIG. 9, the vertical axis indicates the x coordinate value and the horizontal axis indicates the step number. The training data (the x coordinate values for 1000 steps) for the ESN was provided with noise in accordance with a Gaussian distribution (mean μ=0, standard deviation σ=1.5). The graph R1 indicates the x coordinate values of the Rossler system, and the graph R3 indicates the x coordinate values predicted by an ESN constructed with training data including noise (corresponding to the first-stage ESN). Compared with the example illustrated in FIG. 8, the prediction accuracy is lower. It can be seen that, in the case of the Rossler system also, as with the Lorenz system, if the ESN is constructed with training data including noise, the prediction accuracy becomes lower.

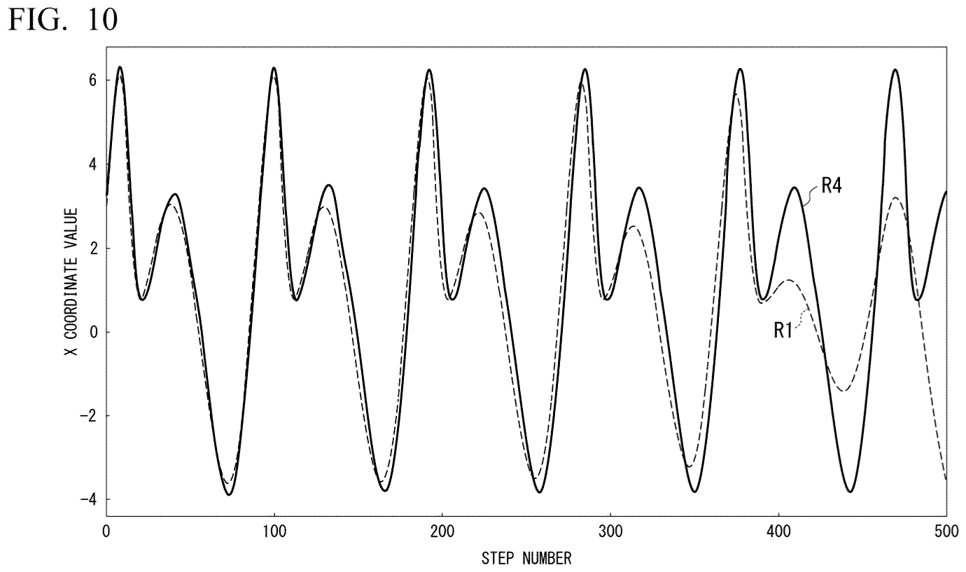

FIG. 10 indicates an example of prediction results by a second-stage ESN constructed by training with observed data including noise. The training data for the ESN was provided with noise similar to that in the case of FIG. 9. The graph R1 indicates the x coordinate values of the Rossler system, and the graph R4 indicates the x coordinate values predicted by the second-stage ESN according to the present example embodiment constructed by means of training data including noise. As illustrated, prediction results with higher accuracy than the example without noise indicated in FIG. 8 are obtained.

### (Effects)

As explained above, according to the first example embodiment, even in the case in which the training data includes noise, a model with high prediction accuracy can be constructed by generating training data with noise removed by a Kalman smoother, and using the de-noised training data for training.

### Second Example Embodiment

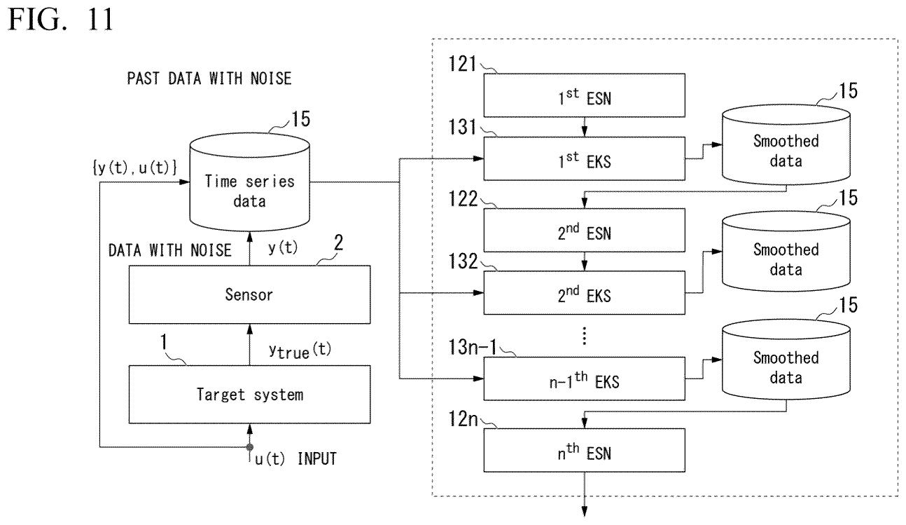

Next, another method for constructing an ESN will be explained with reference to FIG. 11. With this method, a process of constructing an ESN, de-noising training data by means of a Kalman smoother, and constructing a next-stage ESN is repeated multiple times.

FIG. 11 illustrates a configuration example of a process for constructing an N-th stage ESN for the system 1. As with the process explained in FIG. 2, an input value u(t) at a time t is input to the system 1 of the identification target. The input of the input value u(t) causes the state of the system 1 to change to the state yₜᵣᵤₑ(t). When this state is detected by the sensor 2, the observed value y(t) is obtained. This process is repeatedly executed while the system 1 is running, and time series data of input values u(t) and observed values y(t) are accumulated in the storage unit 15.

Next, the training unit 12 reads out the time series data of the input values u(t) and the observed values y(t) with noise from the storage unit 15, and constructs a first-stage ESN 121 by using this time series data as training data. Next, the smoothing unit 13 uses the input values u(t) and the observed values y(t), and the first-stage ESN 121, to generate de-noised observed values (close-to-true time series data) by means of the Kalman smoother 131, and records the values in the storage unit 15. Next, the training unit 12 reads out the time series data of the de-noised observed data and the time series data of the input values u(t) from the storage unit 15, and uses this time series data as training data to construct a second-stage ESN 122. Next, the smoothing unit 13 uses the input values u(t) and the de-noised observed values, and the second-stage ESN 122 to further smooth the de-noised observed values by means of a second Kalman smoother 132, and records the values in the storage unit 15. Subsequently, a process of using a k-th stage (3≤k≤n−1) ESN to smooth the training data by means of a k-th Kalman smoother 13k, and training with the smoothed training data to construct a (k+1)-th stage ESN is repeated until k=n−1 (n being a prescribed natural number). Due to this process, the accuracy of the training data can be increased and the training data with improved accuracy can be used to construct an ESN, thereby identifying a target system with higher accuracy.

### Third Example Embodiment

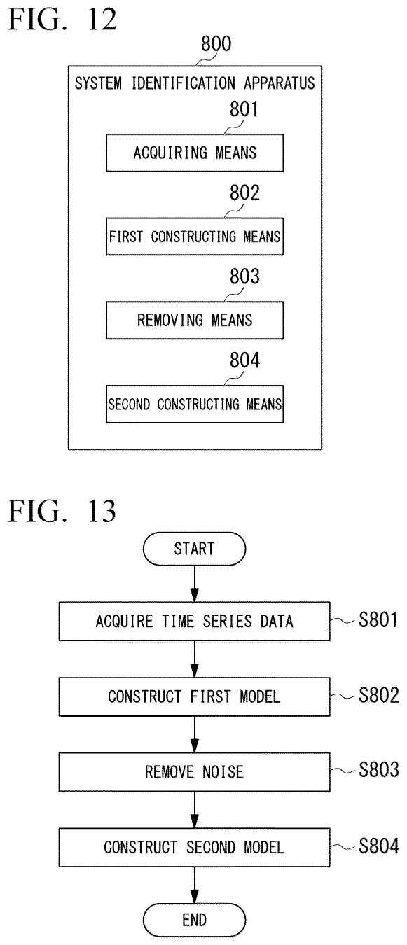

FIG. 12 is a second diagram illustrating an example of a system identification apparatus according to an example embodiment.

The system identification apparatus 800 is provided with acquiring means 801 for acquiring time series data of input values to an identification target and observed values indicating states of the identification target; first constructing means 802 for constructing a first model obtained by identification of the identification target by training with the time series data; removing means 803 for removing noise from the time series data based on the time series data and predicted values of the states of the identification targets predicted by the first model based on the time series data; and second constructing means 804 for constructing a second model obtained by identification of the identification target by training with the time series data from which the noise has been removed.

FIG. 13 is a second flow chart indicating an example of a system identification process according to an example embodiment.

The acquiring means 801 acquires time series data of input values to the target and observed values indicating states of the identification target (step S801). The first constructing means 802 constructs a first model obtained by system identification of the identification target by training with the time series data (step S802). The removing means 803 removes noise from the time series data based on the time series data and predicted values of states of the identification target predicted by the first model based on the time series data (step S803). The second constructing means 804 constructs a second model obtained by identification of the identification target by training with the time series data from which the noise has been removed (step S804).

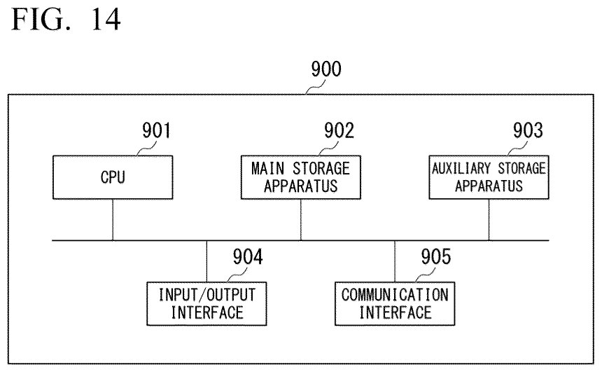

FIG. 14 is a diagram illustrating an example of the hardware configuration of a system identification apparatus according to an example embodiment. A computer 900 is provided with a CPU 901, a main storage apparatus 902, an auxiliary storage apparatus 903, an input/output interface 904, and a communication interface 905. The system identification apparatus 10 mentioned above is implemented in the computer 900. Furthermore, the respective functions mentioned above are stored in the auxiliary storage apparatus 903 in the form of a program. The CPU 901 reads the program from the auxiliary storage apparatus 903, loads it in the main storage apparatus 902, and executes the above-mentioned processes in accordance with the program. Additionally, the CPU 901 secures storage areas in the main storage apparatus 902 in accordance with the program. Additionally, the CPU 901 secures storage areas for storing data being processed in the auxiliary storage apparatus 903 in accordance with the program.

A program for realizing all or some of the functions of the system identification apparatus 10 may be recorded on a computer-readable recording medium, and the program recorded in this recording medium may be read into a computer system and executed to perform the processes according to the respective functional units. The “computer system” mentioned in this case includes an OS and hardware such as peripheral devices. Additionally, the “computer system”, when using a www system, also includes a homepage-providing environment (or a display environment). Additionally, a “computer-readable recording medium” refers to a portable medium such as a CD, a DVD, a USB, etc., or to a storage apparatus, such as a hard disk, internally provided in the computer system. Additionally, in the case in which this program is distributed to the computer 900 by means of communication lines, the computer 900 that has received the distributed program may load said program in the main storage apparatus 902 to execute the above-mentioned process. Additionally, the above-mentioned program may be for realizing just some of the aforementioned functions, and furthermore, the aforementioned functions may be able to be realized by being combined with a program already recorded in a computer system.

As mentioned above, technology using a trained model constructed with an ESN is disclosed. When using an ESN, there is a possibility that the accuracy of the model will become lower due to the influence of noise included in the training data.

According to the present disclosure, for example, even if noise is included in the training data, system identification can be performed with high accuracy to construct a model of a target.

While an example embodiment of the present disclosure has been explained in detail with reference to the drawings above, the specific configurations are not limited to those mentioned above, and various design modifications, etc. are possible within a range not departing from the gist of this disclosure. Additionally, an example embodiment of the present disclosure can be variously modified within the range indicated in the claims, and embodiments obtained by appropriately combining the technical means disclosed respectively in different example embodiments are also included within the technical scope of the present disclosure. Additionally, configurations in which elements described in the example embodiments and modified examples mentioned above and providing similar effects are replaced with each other are also included. Furthermore, the respective example embodiments can be combined, as appropriate, with other example embodiments.

Some or all of the example embodiments described above may be described as in the appendices below. However, the possible example embodiments are not limited to those indicated below.

### Appendix 1

A system identification apparatus comprising: means for acquiring time series data of input values to an identification target and observed values indicating states of the identification target; means for constructing a first model obtained by identification of the identification target by training with the time series data; means for removing noise from the time series data based on the time series data and predicted values of states of the identification target predicted by the first model based on the time series data; and means for constructing a second model obtained by identification of the identification target by training with the time series data from which the noise has been removed.

### Appendix 2

The system identification apparatus according to appendix (1), wherein: the means for constructing the first model constructs the first model; the means for removing the noise uses the first model to remove the noise from the time series data; thereafter, a process in which the means for constructing the first model re-constructs the first model by training with the time series data from which the noise has been removed, and the means for removing the noise uses the re-constructed first model to remove noise from the time series data is performed once or repeated multiple times; and the means for constructing the second model constructs the second model by training with the time series data from which the noise has been removed, generated by the process being performed once or repeated multiple times.

### Appendix 3

The system identification apparatus according to appendix (1) or appendix (2), wherein the identification target is a non-linear dynamical system whose behavior changes non-linearly over time.

### Appendix 4

The system identification apparatus according to any one of appendix (1) to appendix (3), wherein the first model and the second model are reservoir computing.

### Appendix 5

The system identification apparatus according to any one of appendix (1) to appendix (3), wherein the first model and the second model are echo state networks.

### Appendix 6

The system identification apparatus according to any one of appendix (1) to appendix (5), wherein the means for removing the noise removes the noise with a Kalman smoother.

### Appendix 7

The system identification apparatus according to any one of appendix (1) to appendix (6), wherein the means for removing the noise calculates time series data of estimated values indicating states of the identification target by a Bayesian filter based on the time series data of the observed values and the time series data of the predicted values predicted by the first model based on the time series data of the observed values, and further corrects the time series data of the estimated values.

### Appendix 8

The system identification apparatus according to any one of appendix (1) to appendix (7), wherein the means for acquiring the time series data acquires the time series data from the identification target while the identification target is operating; the means for constructing the first model constructs the first model while the identification target is operating; the means for removing the noise removes the noise while the identification target is operating; and the means for constructing the second model constructs the second model while the identification target is operating.

### Appendix 9

The system identification apparatus according to any one of appendix (1) to appendix (8), further comprising means for predicting states of the identification target by inputting the input values and the observed values to the second model.

### Appendix 10

The system identification apparatus according to appendix (9), wherein: the means for acquiring the time series data acquires the time series data from the identification target while the identification target is operating; the means for constructing the first model constructs the first model while the identification target is operating; the means for removing the noise removes the noise while the identification target is operating; the means for constructing the second model constructs the second model while the identification target is operating; and the means for predicting predicts future states of the operating identification target based on the second model that has been constructed while the identification target is operating.

### Appendix 11

A system identification method comprising: acquiring time series data of input values to an identification target and observed values indicating states of the identification target; constructing a first model obtained by identification of the identification target by training with the time series data; removing noise from the time series data based on the time series data and predicted values of states of the identification target predicted by the first model based on the time series data; and constructing a second model obtained by identification of the identification target by training with the time series data from which the noise has been removed.

### Appendix 12

The system identification method according to appendix (9), wherein: the first model is constructed and the first model is used to remove noise from the time series data; thereafter, a process of re-constructing the first model by training with the time series data from which the noise has been removed, and using the re-constructed first model to remove noise from the time series data is performed once or repeated multiple times; and thereafter, the second model is constructed by training with the time series data from which the noise has been removed, generated by the process being performed once or repeated multiple times.

### Appendix 13

A program for making a computer function as: means for acquiring time series data of input values to an identification target and observed values indicating states of the identification target; means for constructing a first model obtained by identification of the identification target by training with the time series data; means for removing noise from the time series data based on the time series data and predicted values of states of the identification target predicted by the first model based on the time series data; and means for constructing a second model obtained by identification of the identification target by training with the time series data from which the noise has been removed.

### Appendix 14

The program according to appendix (11), wherein: the means for constructing the first model constructs the first model; the means for removing the noise uses the first model to remove the noise from the time series data; thereafter, a process in which the means for constructing the first model re-constructs the first model by training with the time series data from which the noise has been removed, and the means for removing the noise uses the re-constructed first model to remove noise from the time series data is performed once or repeated multiple times; and the means for constructing the second model constructs the second model by training with the time series data from which the noise has been removed, generated by the process being performed once or repeated multiple times.

For the system identification methods in appendix 11 and appendix 12 and the programs in appendix 13 and appendix 14, the embodiments in appendix 3 to appendix 10 can be applied.

While preferred example embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A system identification apparatus comprising:
at least one memory configured to store instructions; and
at least one processor configured to execute the instructions to:
acquire time series data of input values to an identification target and observed values indicating states of the identification target;
construct a first model obtained by identification of the identification target by training with the time series data;
remove noise from the time series data based on the time series data and predicted values of states of the identification target predicted by the first model based on the time series data; and
construct a second model obtained by identification of the identification target by training with the time series data from which the noise has been removed.

2. The system identification apparatus according to claim 1,
wherein the at least one processor is configured to execute the instructions to:
in constructing the first model, construct the first model;
in removing, use the first model to remove the noise from the time series data; thereafter,
a process in which the constructing the first model re-constructs the first model by training with the time series data from which the noise has been removed, and the removing the noise uses the re-constructed first model to remove noise from the time series data is performed once or repeated multiple times; and
in constructing the second model, construct the second model by training with the time series data from which the noise has been removed, generated by the process being performed once or repeated multiple times.

3. The system identification apparatus according to claim 1, wherein the identification target is a non-linear dynamical system whose behavior changes non-linearly over time.

4. The system identification apparatus according to claim 1, wherein the first model and the second model are reservoir computing.

5. The system identification apparatus according to claim 1, wherein the first model and the second model are echo state networks.

6. The system identification apparatus according to claim 1, wherein the at least one processor is configured to execute the instructions to, in removing, remove the noise with a Kalman smoother.

7. The system identification apparatus according to claim 1,
the at least one processor is further configured to execute the instructions to predict states of the identification target by inputting the input values and the observed values to the second model.

8. The system identification apparatus according to claim 7,
wherein the at least one processor is configured to execute the instructions to:
in acquiring, acquire the time series data from the identification target while the identification target is operating;
in constructing the first model, construct the first model while the identification target is operating;
in removing, remove the noise while the identification target is operating;
in constructing the second model, construct the second model while the identification target is operating; and
in predicting, predict future states of the operating identification target based on the second model that has been constructed while the identification target is operating.

9. A system identification method comprising:
acquiring time series data of input values to an identification target and observed values indicating states of the identification target;
constructing a first model obtained by identification of the identification target by training with the time series data;
removing noise from the time series data based on the time series data and predicted values of states of the identification target predicted by the first model based on the time series data; and
constructing a second model obtained by identification of the identification target by training with the time series data from which the noise has been removed.

10. A non-transitory storage medium that stores a program for making a computer execute processes for:
acquiring time series data of input values to an identification target and observed values indicating states of the identification target;
constructing a first model obtained by identification of the identification target by training with the time series data;
removing noise from the time series data based on the time series data and predicted values of states of the identification target predicted by the first model based on the time series data; and
constructing a second model obtained by identification of the identification target by training with the time series data from which the noise has been removed.
